(19) United States
(12) Patent Application Publication
(10) Pub. No.: US 2012/0211931 A1
(43) Pub. Date: Aug. 23, 2012

(54) COMPOSITE LEAF SPRING

(76) Inventor: Rupert S. Fane De Salis, Ann Arbor, MI (US)

(21) Appl. No.: 13/504,222

(22) PCT Filed: Oct. 26, 2010
(86) PCT No.: PCT/US10/54062

§ 371 Date: Apr. 26, 2012

Related U.S. Application Data
(60) Provisional application No. 61/254,920, filed on Oct. 26, 2009.

(51) Int. Cl. F16F 1/18; F16F 1/26; B60G 11/02

(52) U.S. Cl. 267/158

(57) ABSTRACT

A composite leaf spring having a central section with opposed ends, and optionally end sections connected thereto, and including a fiber reinforced body composed of a fiber reinforcement embedded within a cured resin. The fiber reinforcement is formed from layers of a web having strands extending longitudinally in the direction of the length of the leaf spring and further having a plurality of transverse elements extending transversely relative to that length. The fiber reinforcement is impregnated with the resin upon molding.

### BACKGROUND OF THE INVENTION

1. Field of the Invention

The present invention generally relates to vehicle suspension systems. More specifically, the invention relates to a composite leaf spring for use in a vehicle suspension system.

2. Related Technology

Springs, and in particular coil and leaf springs, are often used to form a portion of a vehicle suspension system. The suspension system supports the vehicle's running gear (wheels, axles and portions of the drive train, for example), from the vehicle's frame. By suspending the vehicle's running gear, stability is provided to the vehicle as the vehicle is subjected to the operational forces that occur during movement of the vehicle. As used herein, the term vehicle is intended to include passenger automobiles, non-passenger automobiles, light duty trucks (such as pick-up trucks), medium and heavy duty trucks, special or multi-purpose vehicles (such as vans and sport utility vehicles), trailers for these vehicles, and railway vehicles, including railcars.

Historically, leaf springs, such as those found in the front or rear suspension of a passenger or non-passenger vehicle, have been formed of a single or multiple number of metal leaves, which may have included having rubber disposed between the leaves. These metal leaf springs, however, are extremely heavy, adding significant weight to the vehicle, and are cumbersome to manipulate during installation.

With recent automotive emphasis being placed on more fuel efficient vehicles, there has been an effort to replace the heavy metal leaf springs of vehicles with various alternatives. One alternative has been the composite leaf spring.

Composite leaf springs have been typically constructed by molding reinforcement fibers within a plastic material, such as an epoxy matrix or other thermoset polymer resins. The fibers are provided in the form of long strands that are impregnated with the plastic material, and which are then wound on a frame before being placed in a mold, which is subsequently filled with the matrix/ resin. The matrix/resin then sets through chemical reaction and/or applied heat thereby forming the leaf spring.

### SUMMARY OF THE INVENTION

The present invention provides a construction for a molded composite leaf spring. According to one aspect of the invention, the composite leaf spring comprises a straight or curved central section having opposed ends and, optionally, a pair of end sections. Each of the end sections, if provided, is unitarily formed with one of the ends of the central section. The composite leaf spring is more specifically comprised of a fiber reinforced body composed of a fiber reinforcement embedded within a cured resin. The fiber reinforcement is made up of multiple layers of a web that extends substantially completely through the central section and ends (and end sections if provided) of the composite leaf spring. The web itself includes multiple strands that extend longitudinally along the web, generally in the direction of the length of the fiber reinforced body. Further, the web includes a series of transverse elements that extend transversely (obliquely or generally perpendicular) relative to the length, and therefore width-wise, of the fiber reinforced body. The fiber reinforcement is encapsulated with the cured resin such that the strands and transverse elements are collectively impregnated with the cured resin.

In another aspect of the invention, the transverse elements are either interwoven or non-interwoven with the strands of the web.

In additional aspect of the invention, the layers of the web are unitarily formed and continuous with one another.

In yet another aspect of the invention, the transverse elements are located between adjacent layers of the strands.

In still another aspect of the invention, the transverse elements are themselves provided as strands or fibers.

In an additional aspect of the invention, the transverse elements and strands are stitched together.

In a further aspect of the invention, the composite leaf spring includes cylindrical inserts that define openings extending laterally through the end sections. The cylindrical inserts provide a mounting location for bolts and/or flexible or rigid bushings that attach the composite leaf spring to structural components of the vehicle.

In yet a further aspect of the present invention, the fiber reinforcement includes loops that extend around the cylindrical inserts that define the openings in the end sections.

In yet another aspect of the invention, located about each of the cylindrical inserts is a winding that is formed by a separate and distinct portion of the material forming the web, the winding being independent from the web forming the remainder of the fiber reinforcement.

In yet another aspect of the invention, the central section of the composite leaf spring defines a clamping area, the surface of which is formed by the cured resin. The clamping area cooperates in forming a load bearing bolted/clamped joint between the composite leaf spring and another structural component of the vehicle, whereby a clamping force sufficient to retain the joint is directly borne by the composite material of the spring.

In still a further aspect of the invention, the central section defines longitudinal edges between a top face, side faces and a bottom face, with the longitudinal edges being chamfered. The chamfered edges are formed during the molding process and reduce/eliminate sharp edges that may be encountered by an assembler during the assembly process or chipped and visibly damaged by debris during operation of the vehicle.

In another aspect of the invention, the central section of the composite leaf spring defines a top face, side faces and a bottom face and each of the top, side and bottom faces are planar and lack a mold split line artifact thereon.

In an additional aspect of the present invention, the fiber reinforcement defines lateral side edges and the cured resin defines lateral side faces of the fiber reinforced body, the lateral side edges of the fiber reinforcement being spaced inwardly apart from the lateral side faces of the fiber reinforced body. As such, the fiber reinforced body will not protrude outside of the resin of the body, even after being subjected to routine wear and tear.

In an additional aspect of the invention, the composite leaf spring further comprises the fiber reinforced body being connected to a second fiber reinforced body. The second fiber reinforced body having a central section, end sections and a fiber reinforcement impregnated with a cured resin. The ends of the second fiber reinforced body are spaced apart from the ends of the fiber reinforced body under some conditions of positive, negative or zero load, whereby a dual spring rate is defined by the composite leaf spring.

In a further aspect of the invention, the end sections of at least one of the fiber reinforced body and the second fiber reinforced body includes a wear protector, such as a rub plate, or a tip protector or both, mounted thereto and located between the fiber reinforced body and the second fiber reinforced body.

In another aspect of the invention, at least one dowel extends between the central sections of the fiber reinforced body and the second fiber reinforced body thereby limiting relative rotation between the fiber reinforced body and the second fiber reinforced body.

In yet another aspect of the invention, the composite leaf spring further comprises a locating member projecting from a surface of the fiber reinforced body or the second fiber reinforced body. The locating member providing a locating function for precisely locating the composite leaf spring relative to structural components of the vehicle.

In still another aspect of the invention, the locating member is a through bolt extending through the central section of the fiber reinforced body and the second fiber reinforced body so as to retain the fiber reinforced body and the second fiber reinforced body together.

In an additional aspect of the invention, the cured resin is a polyurethane. Further objects, features and advantages of this invention will become readily apparent to a person skilled in the art after a review of the following description, with reference to the drawings, and the claims that are appended to and form a part of this specification.

### BRIEF DESCRIPTION OF THE DRAWINGS

FIG. 1 is perspective view of a composite leaf spring incorporating the principles of the present invention;

FIG. 2 is a perspective view of a fiber reinforcement that is incorporated into the composite leaf spring seen in FIG. 1;

FIG. 3 is a cross-sectional view generally taken along lines 3-3 in FIG. 1 showing the fiber reinforced body located within a mold;

FIG. 4 is a partial perspective view of a single layer of a web utilized in forming the fiber reinforcement seen in FIG. 2;

FIG. 5 is a cross-sectional view, similar to that seen in FIG. 3, of an alternative embodiment for the fiber reinforcement;

FIG. 6 is an enlarged perspective view of a single layer of the web utilized in forming the fiber reinforcement of the alternative embodiment of FIG. 5;

FIG. 7 is a cross-sectional view, generally taken along lines 7-7 in FIG. 1, of an end section of a composite leaf spring incorporating the principles of the present invention; and

FIG. 8 is a partial side view of a dual rate composite leaf spring incorporating the principles of the present invention.

### DETAILED DESCRIPTION OF THE PREFERRED EMBODIMENTS

Referring now to FIGS. 1-7, a composite leaf spring embodying the principles of the present invention is illustrated therein and generally designated at 20. The composite leaf spring 20 generally includes a central section 22 with a pair of opposing ends and, optionally, a pair of end sections 24, the latter of which are unitarily formed with the opposing ends of the central section 22 so as to define a one-piece construction. The end sections 24 each further include a cylindrical insert, such as a bushing 26, that defines an opening 28 extending laterally through the end sections 24. This opening 28 is provided so as to receive the connection member (not shown) allowing the leaf spring 20 to be connected to a vehicle by conventional means known to those skilled in the art. The bushing 26 may be formed from a variety of materials including, without limitation, metals and plastics. While principally shown and described herein as including unitarily formed end sections 24, it will be appreciated that the composite leaf spring 20 can be constructed without the end sections 24. As such, the composite leaf spring 20 may have all of the features and alternatives described herein, absent the end sections 24 and the associated bushings 26 and their windings 44. When provided without the end sections 24, the opposing ends of the central section 22 are mounted to the vehicle by way of other means. One such construction for a mounting may include metal pads located on opposing top and bottom surfaces of the ends of the central section 22 and that are riveted together to secure them to the ends of the central section 22. The pads may then include an integral eye portion that is connected to the vehicle via a shackle or direct connection.

The central and end sections, 22, 24 are portions of a fiber reinforced body 30, which is further composed of a fiber reinforcement 32 embedded within a cured resin 34 such that the cured resin impregnates the fiber reinforcement 32.

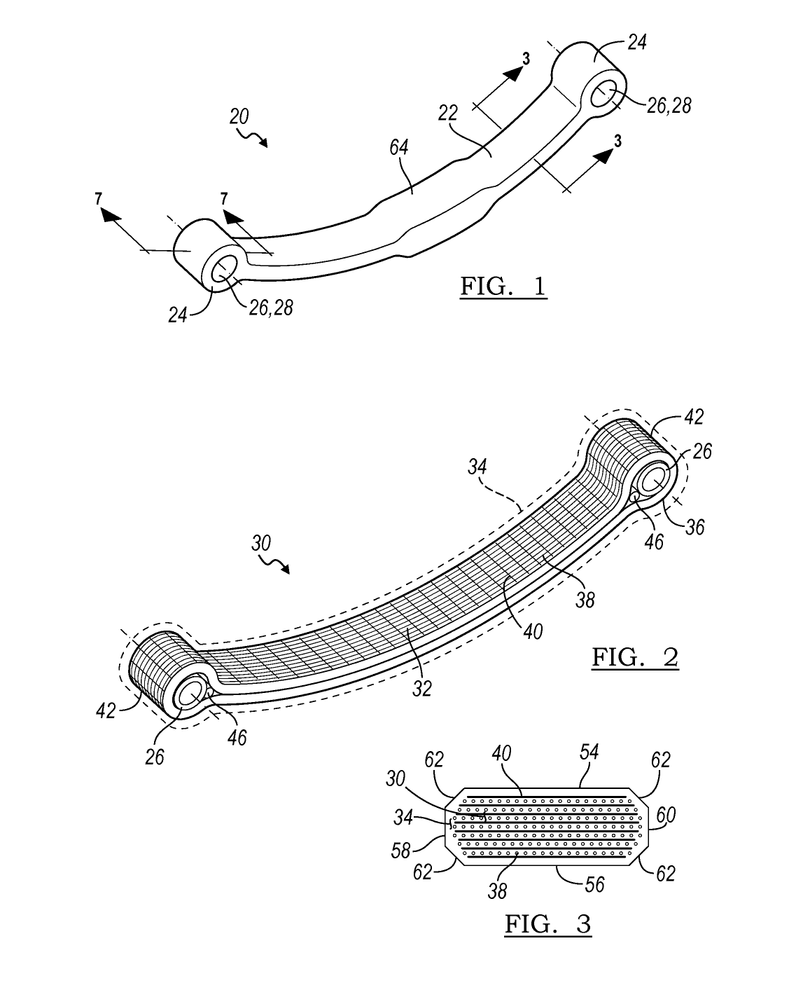

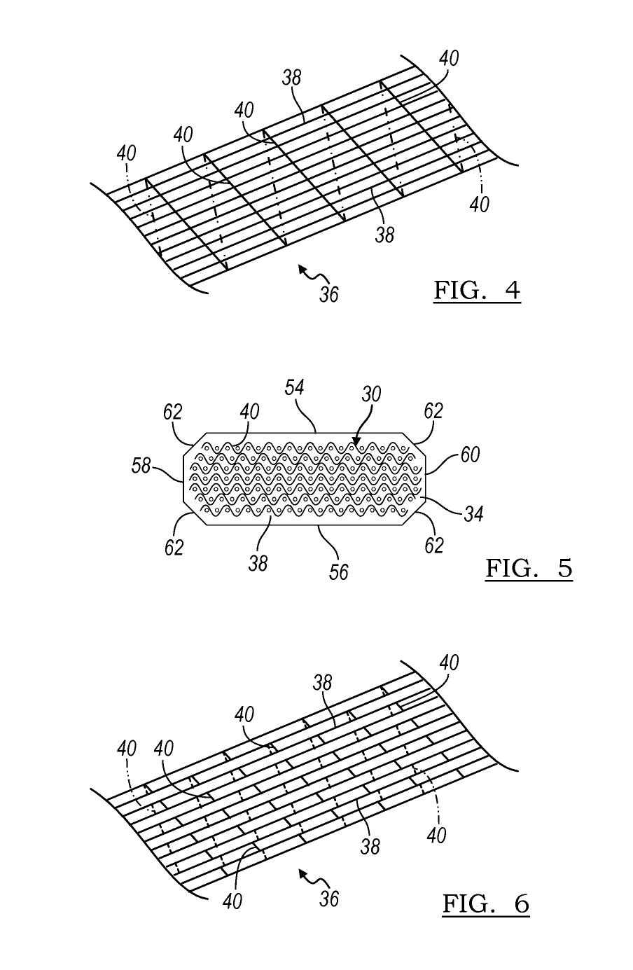

A continuous web 36 (comprised of a grouping of, longitudinally oriented strands 38 of fibers and/or individual fibers) forms the base structure of the fiber reinforcement 32. In addition to the strands 38, the web 36 includes a series of transversely extending elements 40, which extend generally perpendicularly (solid lines in FIGS. 4 and 6) or obliquely (dashed lines in FIGS. 4 and 6) relative to the longitudinal direction of the strands 38 of the web 36. These transverse elements 40 may themselves be provided in the form of strands, similar to strands 38, or alternatively may be composed of individual fibers of the same type of material as the strands 38 or other types of materials, as mentioned below. Additionally, the transverse elements 40 are preferably secured to the strands 38 so as to retain the strands 38 together during the assembly process. In providing the transverse elements 40, they may be located to one side of the strands 38 and not non-interwoven therewith, as is seen in FIG. 4, as well as in FIGS. 2 and 3. Alternatively, the transverse elements 40 may be interwoven with the strands 38 of the web 36. Such an alternative construction is generally illustrated in FIGS. 5 and 6. To secure the transverse elements 40 to the strands 38 of the web 36, the transverse elements 40 may be secured by stitching or other means to the strands 38.

Preferably, the strands 38 and the transverse elements 40 are formed of mineral fibers, such as glass or carbon fibers. Alternatively, the strands 38 and transverse elements 40 may be formed of materials such as carbon fibers, vegetable fibers, animal fibers, synthetic fibers, cellulose fibers or even metal fibers.

To form the fiber reinforcement 32, the web 36, which may be provided on a reel or spool (not shown), is wound about a forming tool so as to produce continuous multiple layers of the web 36. The forming tool (not shown) may thus include the previously mentioned bushings 26 if the end sections 24 are being formed in the leaf spring 20.

Since in the area of the bushing 26 the fiber reinforcement 32 forms a loop 42 about the bushing 26, the layers of the web 36 defining the loop 42 have a thickness that is approximately ½ of the overall thickness of the layers in the fiber reinforcement 42 in the area immediately prior to the formation of the loop 42. The structural strength provided by the layers of web 36 immediately prior to the formation of the loop 42 is therefore greater than that provided by the layer in the actual loop 42. To provide a comparable amount of strength in the end section 24, a winding 44, of formed from the same type of material as the web 36, is independently provided about the bushing 26. Notably, the winding 44 is separate and distinct from the unitary and continuous nature of the web 36 that forms the fiber reinforcement 32. Preferably, the winding 44 is provided in a thickness substantially equal to the thickness of the loop 42.

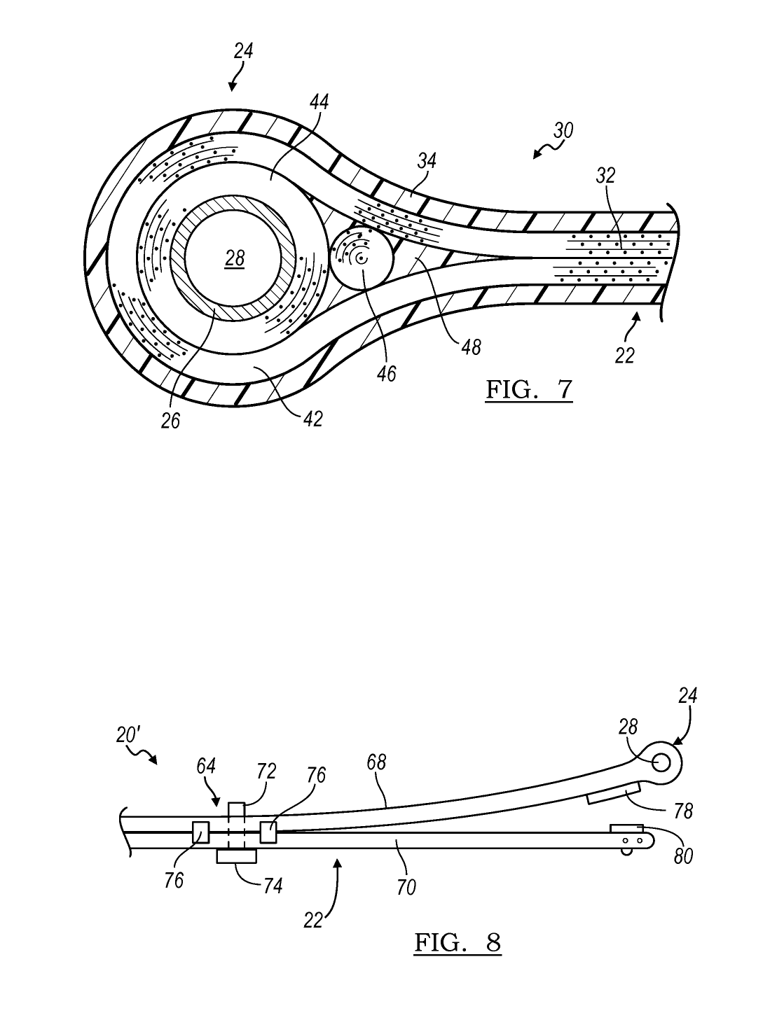

As also seen in FIG. 7, an optional independent winding 46 may be provided in a Y-portion 48, wherein the Y-portion 48 is defined by the loop 42 in that area where the fiber reinforcement 32 initially diverges so as to form the loop 42.

As further seen in FIG. 3, the central section 22 of the composite leaf spring 20 is formed with a cross sectional shape that defines (relative to the orientation of the figure) a top face 54, a bottom face 56 and opposing side faces 58, 60. These faces 54, 56, 58, 60 are planar surfaces. Preferably, but not necessarily, the planar surfaces are formed such that none of the defined faces 54, 56, 58 and 60 include the remnants or artifacts of a mold split or parting line, as typically results from the juncture of mold halves with one another. As seen in FIG. 3, the transition from one face to another face is defined by a chamfer 62. The chamfer 62 and the lack of a mold split artifact on the various faces 54, 56, 58, 60 provides the composite leaf spring 20 with a construction that is visually enhanced and that is enhanced in terms of comfort during manual manipulation and installation, and which also minimizes the potential for chips along sharp edges from rocks and other debris during operation of the vehicle. While small chips and other visual irregularities would not impact the structural integrity of the composite leaf spring 20, such features are aesthetically unpleasing.

During manufacturing, when the fiber reinforcement 32 is initially located within the mold cavity, it is preferred that the side edges of the fiber reinforcement 32 are spaced inwardly apart from the surfaces of the mold cavity. Thus, in the resulting composite leaf spring 20, only cured resin 34 is located in the immediate areas of and along the lateral sides and top and bottom faces 54, 56, 58, 60. The lateral edges of the fiber reinforcement 32 are thus spaced inwardly apart from these faces of the resulting fiber reinforced body 30. Benefits of this construction include eliminating the possibility of an operator obtaining a splinter from the fiber reinforcement 32, as well as preventing the infiltration of water and/or other substances into the composite leaf spring 20.

Preferably the resin material forms a polyurethane thermoset polymer or polyurethane-polyurea thermoset polymer. However, other thermoset polymers derived from epoxy or polyester-styrene resins could be used. The formulation of the polyurethane or other thermoset polymers is selected so that the resin will cure at an appropriate time during the molding process, such that the web is fully wetted and the mold is completely filled when the resin begins to cure. While polyurethane is the preferred material for the resin, other materials having similar characteristics as polyurethane (for example, other polymers or thermoset materials having similar properties such as viscosity) may be used.

The incorporation of the transverse elements 40 with the web 36 into the fiber reinforcement 32 provides the composite leaf spring 20 with enhanced torsional, oblique and compressive strength. Having enhanced compressive strength allows the composite leaf spring 20 to be clamped to the axle of the vehicle without the use of a conventional metal cage, bracket or compliant pad about the composite leaf spring 20. The composite leaf spring 20 is therefore provided with a clamping area 64 (see FIG. 1) whose surface is defined by the cured resin 34 of the fiber reinforcement body 30.

This clamping area 64 may be formed with an increased thickness, relative to other portions of the central section 22, by initially providing an increased number of shorter windings of the web 36 in this area. During manufacturing, the formation of these reduced length windings is done prior to the extending of the windings of the web 36 into the end sections 24, and the forming.

Multiple fiber reinforced bodies may be constructed in accordance with the principles of the present invention, as described above, and subsequently incorporated together so as to form a composite leaf spring 20 with a dual spring rate. Such a construction is generally illustrated in FIG. 8. As seen therein, a first leaf 68 having a construction substantially similar to that seen in FIG. 1 is provided in conjunction with a second leaf 70. The second leaf 70 is also constructed substantially similar to that discussed above. However, the second leaf 70 lacks the formation of an opening in its ends because the mounting of its ends directly to the vehicle is not required.

The first leaf 68 is curved relative to the second leaf 70, resulting in the end sections 24 of the first and second leaves 68, 70 being spaced apart from one another when the composite leaf spring 20 is mounted on the vehicle. During operation of the vehicle, as the first leaf 68 compresses, it provides a first spring rate. When the first leaf 68 is sufficiently compressed so that it is engaged along its length with the second leaf 70, the composite leaf spring 20 is thereafter provided with a second spring rate. Such a dual spring rate construction for the leaf spring 20 will have particular utility in light duty trucks and special/multi-purpose vehicles.

To secure the first and second leaves 68, 70 to one another and aid in assembly into the vehicle, a through bolt 72 is extended centrally through the first and second leaves 68, 70, generally in the area defined as the clamping area 64. Preferably, a head 74 of the through bolt protrudes relative to the surface of the second leaf 70. This protruding head 74 can thereafter be used to locate the composite leaf spring 20 relative to the axle of the vehicle during mounting by virtue of a locating recess formed therein. However, it should be noted that the protruding of the head 74 is optional, as is the use of a through bolt itself.

To prevent relative rotation between the two leaves 68, 70, one or more dowels 76 may be provided. The dowels 76 are positioned in bores defined in both of the leaves 68, 70. Preferably, the bores are located in the clamping area 64 and formed into the contacting surfaces of the first and second leaves 68, 70. It is also preferred that the bores and dowels 76 do not extend completely through the first and second leaves 68, 70. The dowels 76 may alternatively be molded in-place in the material of one of the leaves 68, 70.

To limit abrasion and rubbing between the first and second leaves 68, 70, the adjacent surfaces of the ends of the leaves 68, 70 may include contact pads or wear protectors, such as rub plates and/or tip protectors 78, 80. In order to mount a rub plate 78 to one of the leaves 68, 70, the rub plate 78 may be riveted or otherwise secured between the opposing leaves at a location apart from the ends of the leaves 68, 70. Similarly, the tip protector 80 may be riveted or bolted to an adjacent surface near an end of the opposing leaf 68, 70. The rub plate 78 and tip protector 80 may be formed from a variety of durable, wear resistant materials, including, without limitation, metal, plastic or rubber. Additionally, the rub plate 78 and tip protector 80 each may be formed in a variety of shapes, such as a rectangular, circular or oval, and configurations, such as a flat, curved or domed.

As a person skilled in the art will readily appreciate, the above embodiments have been described so as to illustrate the implementation of the principles of the present invention. This description is not intended to limit the scope or application of this invention. Those skilled in the art will further appreciate that the invention is susceptible to modification, variation and change, without departing from the spirit thereof, as defined in the following claims.

1. A composite leaf spring comprising:
a fiber reinforced body defining a length and a width, the body having a central section and a pair of opposed ends each being unitarily formed with the central section, the body further having a fiber reinforcement encapsulated within cured resin to define the body, the fiber reinforcement extending substantially completely lengthwise through the central section and the ends, the fiber reinforcement being comprised of a plurality of layers of a web, the web being further defined by a plurality of strands extending longitudinally along the web and in the direction of the length of the fiber reinforced body, the web further including a plurality of transverse elements extending transverse to the strands and generally width-wise direction relative to the fiber reinforced body, the fiber reinforcement being encapsulated within the cured resin such that the strands and the transverse elements are collectively impregnated with the cured resin.

2. The composite leaf spring of claim 1 wherein the transverse elements are at least one of interwoven and non-interwoven with the strands.

3. The composite leaf spring of claim 1 wherein the plurality of layers of the web are unitarily formed and continuous with one another.

4. The composite leaf spring of claim 1 wherein the transverse elements are located between layers of the strands.

5. The composite leaf spring of claim 1 wherein the transverse elements are provided as laterally extending strands.

6. The composite leaf spring of claim 1 wherein the transverse elements and the strands are stitched together.

7. The composite leaf spring of claim 1 wherein the ends of the central section are unitarily formed with end sections, the end sections each including a cylindrical insert that defines an opening extending laterally through each of the end sections.

8. (canceled)

9. (canceled)

10. The composite leaf spring of claim 1 wherein the transverse elements of the central section cooperate with the cured resin therein to define a clamping area in the middle of the length of the central section, the surface of the clamping area being defined by the cured resin and configured for direct clamping thereon.

11. The composite leaf spring of claim 1 wherein the central section defines longitudinal edges between a top face, side faces and a bottom face, the longitudinal edges being chamfered.

12. The composite leaf spring of claim 1 wherein the central section defines a top face, side faces and a bottom face, each of the top sides and bottom faces being planar and devoid of a mold split line artifact thereon.

13. The composite leaf spring of claim 1 wherein the fiber reinforcement defines lateral side edges and the resin of the body defines lateral side faces, the lateral side edges of the fiber reinforcement being spaced inwardly apart from the lateral side faces of the body.

14. The composite leaf spring of claim 1 wherein the fiber reinforced body is connected to a second fiber reinforced body, the second fiber reinforced body having a central section, a pair of ends unitarily formed therewith and including a fiber reinforcement impregnated with a cured resin, ends of the fiber reinforced body being spaced apart from the ends of the second fiber reinforced body, whereby a dual spring rate spring is defined by the composite leaf spring.

15. (canceled)

16. (canceled)

17. The composite leaf spring of claim 14 wherein at least one dowel extends between the central sections of the fiber reinforced body and the second fiber reinforced body to limit relative rotation there between.

18. The composite leaf spring of claim 14 further comprising a locating member projecting from a surface of the second fiber reinforced body.

19. The composite leaf spring of claim 18 wherein the locating member is a through bolt extending through the central sections of the fiber reinforced body and second fiber reinforced body.

20. The composite leaf spring of claim 1 wherein the cured resin forms one of a polyurethane thermoset polymer or a polyurethane-polyurea thermoset polymer.

21. The composite leaf spring of claim 1 wherein the cured resin forms a thermoset polymer derived from one of an epoxy resin and a polyester-styrene resin.

22. The composite leaf spring of claim 1 wherein the central section is curved.

23. The composite leaf spring of claim 1 wherein at least some of the layers of the web are shorter in length than others of the layers.

24. The composite leaf spring of claim 1 wherein the transverse elements extend transverse to the strands in one of an oblique direction and a perpendicular direction thereto.

25. (canceled)
